(19) United States
(12) Patent Application Publication
(10) Pub. No.: US 2026/0209495 A1
(43) Pub. Date: Jul. 23, 2026

(54) Sealing Material (SH A 50 - 80) for Vacuum Screw Closures

(71) Applicant: ACTEGA DS GMBH, Bremen (DE)

(72) Inventors: Dany Mängel, Twistringen (DE); Matthias Kern, Lilienthal (DE)

(21) Appl. No.: 19/138,252

(22) PCT Filed: Dec. 20, 2022
(86) PCT No.: PCT/EP2022/086942

§ 371 Date: Jun. 12, 2025

(51) Int. Cl. C08L 23/14; B65D 53/06

(52) U.S. Cl. CPC C08L 23/14; B65D 53/06; C08L 2203/10; C08L 2205/03

(57) ABSTRACT

A container closure, in particular a vacuum screw closure, having a sealing element which comprises or consists of a polymer compound, the polymer compound comprising the following: at least one highly vinylic styrene block copolymer; at least one iso-butylene-containing, preferably rubber-type (co-)polymer; a content of more than zero of at least one (Co)PP-containing polymer and optionally other constituents and additives.

The invention relates to a container closure, in particular a vacuum screw closure, having a sealing element comprising or consisting of a polymer compound. More particularly, the invention relates to container closures having a polymer-based sealing insert for bottles and other containers for holding beverages and foodstuffs. The container closures are free of halogen-containing substances and are also suitable for demanding applications.

Beverages and foodstuffs are filled into various types of containers for transport and storage. These containers often need to be sealable so that the contents do not leak and are also protected against the ingress of undesirable substances that would contaminate or damage the contents. In many applications, these are not just solid or liquid contaminants. If the contents are sensitive to gaseous substances, these must also be prevented from entering. This is achieved by an appropriately designed container closure.

Container closures made of metal and/or plastic have long been known. In the form of screw caps, screw closures and crown caps, for example, they are used to seal containers such as bottles, jars and the like. Such containers have a mouth that must be closed by the container closure. A sufficiently tight closure of the container must be ensured in order to prevent the contents of the container from leaking and to protect the contents of the container from the ingress of undesirable substances, including gaseous substances such as oxygen, trichloroanisole and others.

The necessary tightness is usually achieved by a sealing insert, which is made of a material that is both sufficiently strong and elastic and is arranged in the container closure in such a way that it contacts the mouth of the container when the container closure is arranged on the container. The sealing insert is usually arranged in the shape of a disc or ring on the inside of the container closure. In the closed state of the container, it lies against the mouth of the container and is pressed against the mouth by the container closure, wherein its hardness together with its elasticity creates the seal. A good sealing insert compensates for the unevenness that is always present at the mouth of the container. The more uneven the container mouth is, the higher the demands placed on the sealing insert.

A key factor in meeting such requirements is the appropriate choice of the sealing insert material. Many well-known materials are well suited for relatively simple applications, but less so or not at all for more demanding seals.

The sealing insert must also meet other requirements, for example it should be pasteurisable or even sterilisable for many applications by applying heat and, if necessary, pressure. It should be able to withstand considerable internal pressure (e.g. for carbonated drinks), but give way in a controlled manner if this pressure is exceeded (overpressure valve effect).

If the container closure is a screw closure, the sealing insert must not offer too much resistance to the twisting of the container closure on the neck during opening.

In addition, the sealing insert must be as easy as possible to produce and fit in the container closure. It is known to cut disc-shaped sealing inserts from sheets or films and then attach them to the container closure (“out-shell moulding”) or, which is often preferred, to insert them into the container closure in a flowable form, mould them there and solidify them (“in-shell moulding”). In-shell moulding also makes it possible to produce sealing inserts that are not disc-shaped but ring-shaped.

In the case of PVC polymer-based sealing inserts, this is conventionally done by insertion as plastisol with subsequent gelling, wherein profiling of the seal is possible using heated stamps, or in the case of thermoplastic materials by insertion in a heated flowable state, subsequent moulding, and cooling.

While sealing inserts containing PVC were used extensively in the past, PVC and other halogen-containing materials are now the subject of considerable concern. They are considered to be potentially harmful to health and are also not easy to dispose of. In many countries, the use of such halogen-containing materials is regulated or even banned by laws or regulations.

There is therefore a considerable need for container closures that do not require halogen-containing materials without having to forego the advantages that PVC-containing sealing inserts, for example, have in terms of processing, sealing properties, costs and the like.

There are already a number of proposals for this in the prior art.

It has been known for decades to manufacture sealing inserts for screw closures on the basis of polymers that do not contain halogens. These sealing inserts are all “compounds”, i.e. mixtures of one or (usually) several polymers with additives that adapt the properties of the sealing insert to the intended application, facilitate its processing or use and the like.

Typical polymers in such compounds are thermoplastics, especially polyolefins, thermoplastic elastomers, elastic thermoplastics and synthetic rubbers. Typical additives are plasticisers, oils, lubricants, antioxidants, stabilisers, pigments, fillers and the like.

Against this background, it is an object of the invention to propose improved container closures, in particular with regard to the properties of the sealing element.

The combination of features of the independent claim serves to solve this problem.

In particular, the invention provides that the seal contains highly vinylic styrene block copolymers.

Advantageous developments of the invention are defined in the dependent claims.

Based on U.S. Pat. No. 10,457,805 2B, the term “highly vinylic” refers to styrene block copolymers of which the vinyl content is more than 50 mol % before hydrogenation. After hydrogenation, the copolymer naturally contains little or even no unsaturation.

Nevertheless, we also refer to such styrene block polymers as “highly vinylic” because they can be derived from precursors with such high vinyl contents.

By “rubber-type” we mean polymers that are similar to known synthetic rubbers in terms of their mechanical properties (such as hardness and elasticity) that are essential for the sealing function. Butyl rubber (IIR), e.g. the commercially available product, is suitable as a reference substance.

The invention relates specifically to a container closure, in particular a vacuum screw closure, with a sealing element comprising or consisting of a polymer compound, wherein the polymer compound comprises the following:
at least one highly vinylic styrene block copolymer;
at least one iso-butylene-containing, preferably rubber-type (co-)polymer;
a content of more than zero of at least one (co)-PP-based polymer,
and optionally other constituents and additives.

The styrene block copolymer preferably has a styrene content of less than 25 wt. %, based on the total weight of styrene block copolymer.

Hydrogenated styrene block copolymers with butadiene centre blocks (1,2- and/or 1,4-linked), e.g. SEBS and highly vinylic SEEPS, are particularly suitable.

These polymers differ from each other in the molecular centre blocks, which are made up of the hydrogenated sequences of butadiene (1,2- and/or 1,4-linked) and/or isoprene.

Such copolymers can be obtained from Kraton Corp., TSRC Corp. or Dynasol, for example. Typical suitable products are Kraton G1645, Kraton G1643, Vector 8245 or Calprene H6180, among others, e.g. Hybrar 7000, in which isoprene is copolymerised in addition to butadiene.

In preferred embodiments of the container closure according to the invention, the highly vinylic styrene block copolymer is present in a proportion of 20-40 wt. %, based on the total weight of the polymer components in the sealing element.

The styrene block copolymer is preferably relatively soft and has a Shore A hardness of less than 60.

In preferred embodiments of the invention, the styrene block copolymer has an MFI (190° C., 5 kg) of ≥0 g/10 min, wherein the materials according to the invention may not be meltable or are only partially thermoplastic.

In preferred embodiments, the styrene block copolymer comprises an SE(E)PS having a vinyl content prior to hydrogenation of more than 50 mol % and a styrene content of <25 wt. %, based on the total weight of SE(E)PS.

According to the invention, the compound of the sealing element further comprises an isobutylene-containing rubber-type (co-)polymer, which preferably limits or completely prevents the passage of interfering substances, e.g. gases from the environment, i.e. has at least a small barrier effect.

According to the invention, the (co-)polymer is selected from
IIR (butyl rubber);
SIBS;
PIB;
   and mixtures thereof,
   wherein the copolymer preferably has a Shore A hardness of between 20 and 60 and preferably in a content of 10 to 40 wt. %, based on the total weight of the polymers in the sealing material.

In a preferred embodiment of the invention, it is further provided that the (co)PP-based polymer of the sealing element comprises or consists of a PP homopolymer or a PP copolymer with a Shore D hardness of more than 65, wherein the content of the sealing material in this polymer is preferably not more than 20 wt. %, based on the total weight of the polymers in the sealing material.

The main function of this (co)PP content is to give the sealing element sufficient resistance to heat treatment such as pasteurisation or sterilisation, but also to ensure adhesion to the coating systems commonly used in metal closures or the cap material in plastic closures, which is also usually PP-based.

It is currently preferred that the PP-based polymer of the sealing element is a PP homopolymer, wherein PP copolymers with low comonomer contents (typically <5%, especially ethylene) are also suitable. Such materials are available on the market from a large number of manufacturers.

Preference is given to those of which the melt flow index does not exceed 30 dg/min at 230° C. and 2.16 kg coating weight.

In an alternative embodiment of the invention, it is provided that the (co)-PP-based polymer in the sealing element is a PP copolymer with a Shore D hardness of less than 40, preferably between 20 and 70 wt. %, based on the total weight of the polymers in the sealing material. Such more specialised copolymers combine a low hardness for PP-based copolymers with melting points above 140° C.

In this embodiment, the (co-)PP has the same function as before, but materials can be realised that manage with lower contents of the often expensive soft components described above.

In all embodiments, the PP-based polymer in the sealing element may be a PP/PE copolymer. In other preferred embodiments of the invention, the sealing element may additionally or instead comprise or consist of at least one terpolymer, preferably a propene-, ethene- and/or butene-containing terpolymer. The sealing element does not contain PVC within the scope of the analytical methods customary on the date of filing.

The sealing material preferably has an overall Shore A hardness (DIN ISO 7619-1) of 40 to 90, preferably 50 to 80.

In preferred embodiments, the sealing element comprises additional polymers (except PVC), in particular at least one (co)PE, preferably with a melting point (DIN EN ISO 11357-3) above 100°° C., preferably with an MFI (DIN EN ISO 1133, 190° C., 5 kg) of ≤50 g/10 min, in particular in a content of up to 25 wt. %, based on the total weight of the polymers in the sealing material.

In preferred embodiments of the invention, the container closure further comprises conventional additives, e.g. at least one filler such as talc, in particular in a content of up to 20 wt. %, based on the total weight of the sealing element.

In particular, if migration problems are negligible, the hardness of the sealing element can be adjusted by conventional additions of plasticising substances. In these embodiments, the compound of the sealing element contains at least one plasticiser that is liquid at 23° C. and ambient pressure, in particular white oil or a synthetic polyolefin-based oil, preferably in a content of up to 10 wt. %, based on the total weight of the sealing element.

In preferred embodiments, the kinematic viscosity (according to DIN EN ISO 3104) of the plasticiser at 40° C. is above 60mm²/s.

1. A vacuum screw container closure having a sealing element which comprises a polymer compound comprising:
at least one highly vinylic styrene block copolymer;
butyl rubber; and
a content of more than zero of at least one (Co)PP-containing polymer.

2. The container closure according to claim 1, in which the styrene block copolymer has a styrene content of less than 25 wt. %, based on the total weight of styrene-containing polymer.

3. The container closure according to claim 1, in which the styrene block copolymer comprises an SE(E)PS having a vinyl content prior to hydrogenation of more than 50 mol % and a styrene content of <25 wt. %, based on the total weight of SE(E)PS.

4. The container closure according claim 1, in which the styrene block copolymer is present in a proportion of 20-40 wt. %, based on the total weight of the polymer components in the sealing element.

5. The container closure according to claim 1, in which the styrene block copolymer has a Shore A hardness of less than 60 (DIN ISO 7619-1).

6. The container closure according to claim 1, in which the styrene block copolymer has an MFI (190° C., 5 kg; DIN EN ISO 1133) of ≥20 g/10 min.

7. The container closure according to claim 1, further comprising one or more of
SIBS (styrene-isoprene/butadiene-styrene block copolymer);
PIB (polyisobutylene);
and mixtures thereof.

8. The container closure according to claim 1, in which the (Co)PP-containing polymer comprises a PP homopolymer or a PP copolymer with a Shore D hardness of more than 65, wherein the content of the sealing material in this polymer is not more than 20 wt. %, based on the total weight of the polymers in the sealing material.

9. The container closure according to claim 1, in which the (Co)PP-containing polymer comprises a PP copolymer having a Shore D hardness of less than 40, and wherein the content of said polymer in the sealing material is between 20 and 70 wt. %, based on the total weight of polymers in the sealing material.

10. The container closure according to claim 1, wherein the (Co)PP-containing polymer comprises at least one terpolymer, and/or at least one propene- and/or ethene-containing copolymer.

11. The container closure according to claim 1, wherein the sealing material has an overall Shore A hardness of 40 to 90.

12. The container closure according to claim 1, further comprising at least one (co)PE, with a melting point below 100° C., with an MFI (190° C., 5 kg, DIN EN ISO 1133) of ≤50 g/10 min, said (co)PE being present in a content of up to 25 wt. %, based on the total weight of the polymers in the sealing material.

13. The container closure according to claim 1, further comprising at least one filler present in a content of up to 20 wt. %, based on the total weight of the sealing element.

14. The container closure according to claim 1, further comprising at least one plasticiser in a content of up to 10 wt. %, based on the total weight of the sealing element.

15. The container closure according to claim 14, in which the kinematic viscosity (according to DIN EN ISO 3104) of the plasticiser at 40° C. is above 60 mm²/s.

16. A cap comprising a metal or plastic closure and a sealing element, the sealing element comprising a polymer compound, the polymer compound comprising at least one highly vinylic styrene block copolymer; butyl rubber; and a content of more than zero of at least one (Co)PP-containing polymer.
